(19) United States
(12) Patent Application Publication
(10) Pub. No.: US 2015/0309659 A1
(43) Pub. Date: Oct. 29, 2015

(54) METHOD AND TOUCH APPARATUS FOR CALIBRATING COORDINATE VALUE NEAR EDGE OF TOUCH PANEL

(71) Applicant: MStar Semiconductor, Inc., Hsinchu Hsien (TW)

(72) Inventor: Tzu-Wei Liu, Hsinchu County (TW)

(21) Appl. No.: 14/691,725

(22) Filed: Apr. 21, 2015

(30) Foreign Application Priority Data
Apr. 25, 2014 (TW) 103114965

(51) Int. Cl. G06F 3/041; G06F 3/044

(52) U.S. Cl. CPC G06F 3/0418; G06F 3/044

(57) ABSTRACT

A method for calibrating a coordinate near an edge of a touch panel is provided. The method includes: obtaining a calculated coordinate according to a capacitance change corresponding to a proximity event; selecting a first linear function from a plurality of first linear functions included in a look-up table (LUT) according to the calculated coordinate and the capacitance change; and obtaining a calibrated coordinate according to the first linear function and the calculated coordinate.

This application claims the benefit of Taiwan application Serial No. 103114965, filed Apr. 25, 2014, the subject matter of which is incorporated herein by reference.

### BACKGROUND OF THE INVENTION

1. Field of the Invention

The invention relates in general to a touch panel, and more particularly, to a method and apparatus for calibrating a coordinate value near an edge of a touch panel.

2. Description of the Related Art

Touch panels make a large scale industry. Various electronic products adopt touch panels as critical input/output devices for human-machine interfaces. The performance of touch panels depends on sensing electrodes and logic circuits connected thereto. Thus, the design and quality of the sensing electrodes greatly affect the performance of touch panels.

The sensing electrodes of a touch panel are generally formed on a transparent substrate. Light emitted from a display device penetrates the transparent substrate to reach a user. These sensing electrodes formed on the transparent substrate include multiple electrodes, which are connected to the logic circuits via multiple conducting wires. By detecting a minute current on the sensing electrode, the touch panel accordingly learns a proximity (approach or contact) event occurring on the touch panel.

Sensing electrodes usually include multiple sensing electrode units. Each sensing electrode unit at a central region of a touch panel is surrounded by other sensing electrode units. Thus, when a processing module of the touch panel calculates a proximity event at the central region of the touch panel according to a predetermined computing method, a coordinate result obtained does not differ much from calibrated coordinates of the proximity event. However, for sensing electrode units that are located at edges of the touch panel, at least one side of each of these sensing electrode units is not arranged with other sensing electrode units. When a same computing method is utilized to calculate a proximity event occurring at an edge of the touch panel, a coordinate result obtained may differ from calibrated coordinates of the proximity event by a substantial value.

Therefore, there is a need for a method for compensating a computation error, rendering a touch panel to more correctly calculate coordinates of a proximity event occurring near an edge of a touch panel.

### SUMMARY OF THE INVENTION

A method for calibrating a coordinate value near an edge of a touch panel is provided according to an embodiment of the present invention. The method includes: obtaining a calculated coordinate according to a capacitance change corresponding to a proximity event; selecting a first linear function from a plurality of first linear functions included in a look-up table (LUT) according to the calculated coordinate and the capacitance change; and obtaining a calibrated coordinate according to the first linear function and the calculated coordinate.

A touch apparatus for calibrating a coordinate value of a touch panel is provided. The touch apparatus includes a memory module and a processing module. The memory module includes an LUT. The processing module, coupled to the touch panel and the memory module, performs steps of: obtaining a calculated coordinate according to a total capacitance change corresponding to a proximity event; selecting a first linear function from a plurality of first linear functions included in the LUT according to the calculated coordinate and the capacitance change; and obtaining a calibrated coordinate according to the first linear function and the calculated coordinate.

In conclusion, one main spirit of the present invention is to approximate a curve with a plurality of linear functions, so as to reduce memory consumption with less calculation while obtaining a similar corrected value.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a touch apparatus according to an embodiment of the present invention;

FIG. 2 is a schematic diagram of X-coordinate error values according to an embodiment of the present invention;

FIG. 3A is a look-up table (LUT) of square roots of total capacitance changes according to an embodiment of the present invention;

FIG. 3B is an LUT of X-coordinate error values according to an embodiment of the present invention;

FIG. 3C is an LUT of real X-coordinates according to an embodiment of the present invention;

FIG. 4A is a schematic diagram of calculated X-coordinates versus real X-coordinates according to an embodiment of the present invention;

FIG. 4B is a schematic diagram of calculated X-coordinates versus projection areas according to an embodiment of the present invention;

FIG. 5A is a schematic diagram of memory contents according to an embodiment of the present invention;

FIG. 5B is a schematic diagram of memory contents according to an embodiment of the present invention;

FIG. 6 is a calibrating method according to an embodiment of the present invention;

FIG. 7A is a schematic diagram of corrected X-coordinates according to an embodiment of the present invention; and

FIG. 7B is a schematic diagram of corrected X-coordinates according to another embodiment of the present invention.

### DETAILED DESCRIPTION OF THE INVENTION

Embodiments of the present invention are described in detail below. Apart from the disclosed embodiments, the present invention is also applicable to other embodiments. The scope of the present invention is not limited by these non-limiting embodiments, and is defined in accordance with the appended claims. To better describe the contents of the present invention to one person skilled in the art and to keep the drawings clear, parts of the drawings are not drawn to actual sizes and ratios, and certain sizes and other associated scales may be emphasized to appear exaggerated, with unrelated details not entirely depicted.

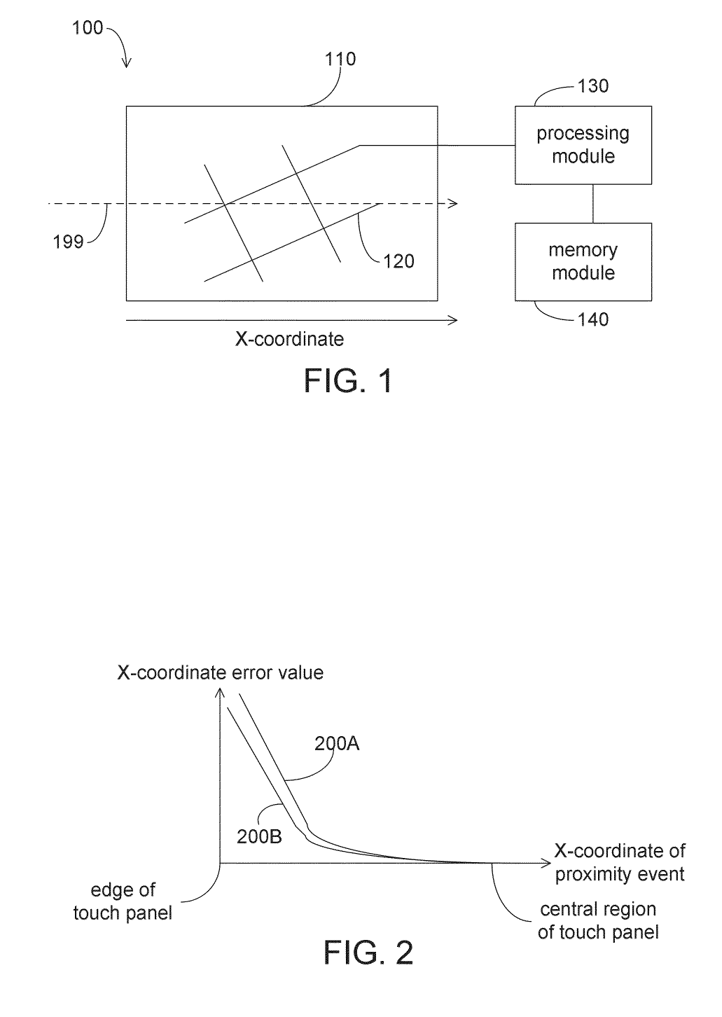

FIG. 1 shows a schematic diagram of a touch apparatus 100 according to an embodiment of the present invention. The touch apparatus 100 includes a touch panel 110, which includes a substrate and a plurality of sensing electrode groups 120 formed on the substrate. The sensing electrode groups 120 are connected to a processing module 130. The processing module 130 includes necessary circuits and is connected to a memory module 140.

The memory module 140 includes necessary program codes and data that can be executed and applied by the processing module 130 to implement a predetermined algorithm. According to certain electrical characteristics detected by the sensing electrode groups 120, the algorithm calculates coordinates of a proximity event occurring on the touch panel 110. One person skilled in the art can understand that, the design of the sensing electrode groups 120 may be in many forms, and the above algorithm corresponds to the design of the sensing electrode groups 120. In other words, when the design of the sensing electrode groups 120 changes, the algorithm also needs to be modified correspondingly. The present invention does not limit connection methods and implementation details of the processing module 130 and the memory module 140. In one embodiment, the processing module 130 and the memory module 140 may be located in the same chip. In another embodiment, the processing module 130 may access the memory module 140 located in a different chip through other circuits or controllers.

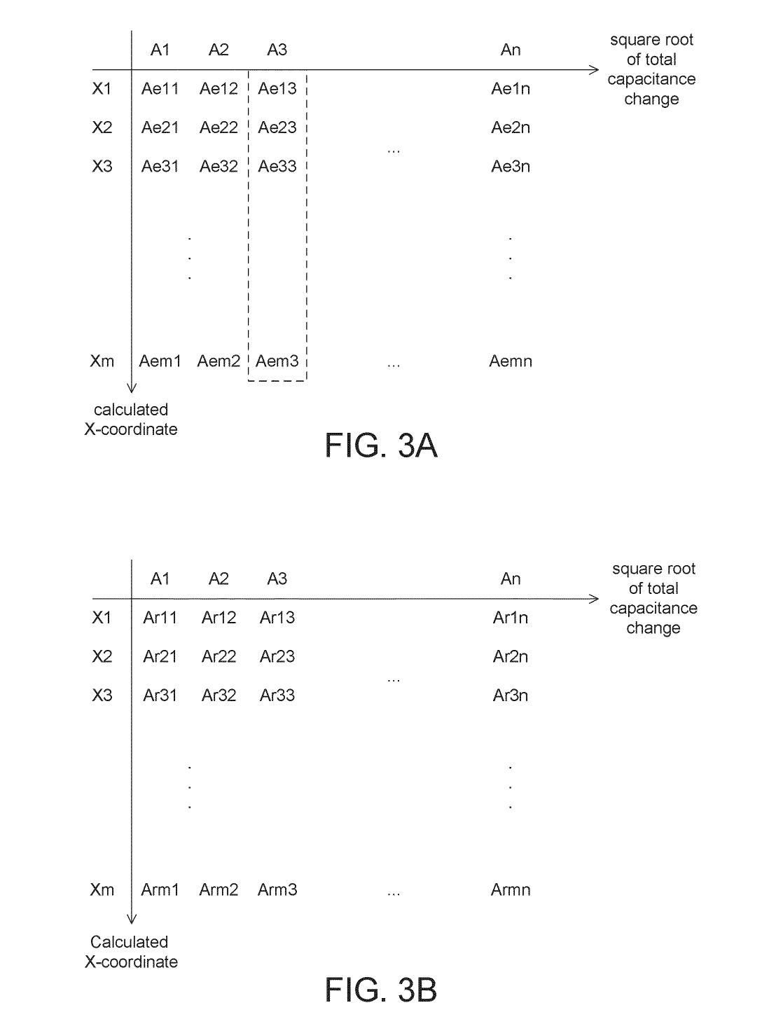

FIG. 2 shows a schematic diagram of X-coordinate error values and compensation values according to an embodiment of the present invention. Assuming that consecutive proximity events are generated on the touch panel 110 in FIG. 1 in a direction 199 parallel to the X-axis, curves 200A and 200B show relations of error values of calculated X-coordinates, which is obtained by the processing module 130 according to an algorithm, and corresponding real X-coordinates of the proximity events. The curve 200A and the curve 200B correspond to different sizes of edge blocks.

It is observed from the curve 200A and 200B that, the error value increases as the proximity event gets nearer to an edge of the touch panel 110. In one embodiment, the sensing electrode groups 120 include a plurality of sensing electrode units arranged along the X-axis to sense a plurality of capacitance changes of the touch panel. Error values of the algorithm applied generates the relations shown in FIG. 2.

In some embodiments, when the touch apparatus 100 is a capacitive type, the capacitance change is associated with a projection area. The processing module 130 first calculates the projection area and a non-corrected X-coordinate through the capacitance change, and identifies a square root of a total capacitance change (capsum) through a pre-established look-up table (LUT), i.e., a square root of a total of capacitance changes caused by an external conductive object approaching or contacting the sensing electrode groups 120. Due to the design of the sensing electrode groups 120, the square root of the total capacitance change caused by a proximity event at a central region of the touch panel 110 is different from the square root of the total capacitance change caused by a proximity event having a same projection area near an edge of the touch panel 110. Thus, after having calculated the above projection area from the capacitance change, the processing module 130 needs to further identify the square root of the total capacitance change according to the position of the proximity event taking place, i.e., the X-coordinate. However, the present invention does not limit the design of the sensing electrode groups or the algorithm used, and the present invention may be implemented given that the curve relations shown in FIG. 2 are present. Please also note that the total capacitance change can be obtained directly by the capacitance change and the position of the proximity event without calculating the projection area.

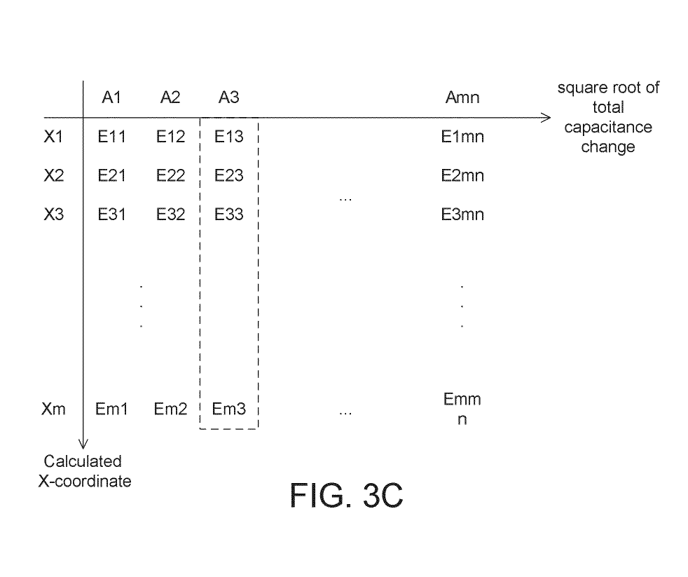

In one embodiment, the memory module 140 includes two LUTs—one for identifying the square root of the total capacitance change according to the X-coordinate of the proximity event, and the other for back-calibrating the X-coordinate according to the total capacitance change. FIG. 3A shows an LUT of square roots of total capacitance changes according to an embodiment of the present invention. In FIG. 3A, the horizontal axis represents the projection area of a proximity event, or a positive ratio of the projection area, e.g., a capacitance change; the vertical axis represents the calculated X-coordinate of a proximity event obtained through the algorithm. Values in the table represent square roots of total capacitance changes. That is to say, the square root of the total capacitance change relates to the calculated coordinate and the capacitance change. Therefore, the following looking up steps can be regarded as being based on the calculated coordinate and the capacitance change.

Once the algorithm performed by the control module 130 has calculated the X-coordinate and the projection area (or the capacitance change) of a proximity event, the above LUT may be utilized to obtain the square root of the total capacitance change.

In one embodiment, differences between every two of the projection areas (or capacitance changes) A1, A2, A3, . . . An of the horizontal axis are equal, and differences between every two of the calculated X-coordinates X1, X2, X3, . . . Xm of the vertical axis are also equal. In the above calculation process, if the calculated X-coordinate and/or the projection area (or the capacitance change) is/are not equal to any value in the LUT, the square root of the total capacitance change may be calculated by interpolation according to two adjacent points. It should be noted that, in another embodiment, the values of the above horizontal axis and/or vertical axis do not need to have equal differences, and the square root of the total capacitance change may also be calculated by interpolation.

Assume that the calculated projection area (or the capacitance change) is A1.3, and the calculated X-coordinate is X2.6. In one embodiment, the square root of the most similar total capacitance change may be directly adopted for the calculation, i.e., Ae31. In another embodiment, interpolation may be first performed on the horizontal axis, i.e., a first difference Ae21.3 is identified by utilizing Ae21 and Ae22, and a second value Ae31.3 is identified by utilizing Ae31 and Ae32, to identify the square root of the real total capacitance change. In another embodiment, interpolation may be first performed on the vertical axis, i.e., a first value Ae2.61 is identified by utilizing Ae21 and Ae31, and a second value Ae2.62 is identified by utilizing Ae22 and Ae32. Next, interpolation is performed on the horizontal axis, i.e., the square root of the real total capacitance change is identified by utilizing the above first value Ae2.61 and second value Ae2.62.

Having identified the square root of the total capacitance change, another LUT may be adopted to correct the X-coordinate of the proximity event. FIG. 3B shows an LUT of X-coordinate error values according to an embodiment of the present invention. In the LUT in FIG. 3, the horizontal axis may represent the square root of the total capacitance of a proximity event, and the vertical axis may represent the calculated X-coordinate of a proximity event obtained through the algorithm. The values in the table represent error values of the X-coordinate. For example, a plurality sets of data E13, E23, E33, . . . Em3 marked by dotted frames may be utilized to reverse deduce the curve 200A shown in FIG. 2.

When the algorithm performed by the control module 130 has obtained the calculated X-coordinate and the square root of the total capacitance change of a proximity event, the above LUT may be utilized to calculate the error value of the X-coordinate. According to the calculated X-coordinate and the error value, the real X-coordinate of the proximity event can be calculated.

In one embodiment, differences between every two of the total capacitance changes A1, A2, A3, . . . Amn of the horizontal axis are equal, and differences between every two of the calculated X-coordinates X1, X2, X3, . . . Xm of the vertical axis are also equal. In the above calculation process, if the calculated X-coordinate and/or the square root of the total capacitance change are/is not equal to any value in the LUT, the error value of the X-coordinate may be calculated by interpolation according to two adjacent points. It should be noted that, in another embodiment, the values of the above horizontal axis and/or vertical axis do not need to have equal differences, and the error value of the X-coordinate may also be calculated by interpolation.

FIG. 3C shows an LUT of real X-coordinates according to an embodiment of the present invention. In the LUT in FIG. 3, the horizontal axis may represent square root of the total capacitance change of a proximity event, and the vertical axis may represent a calculated X-coordinate of a proximity event obtained through the algorithm. The values in the LUT represent corrected real X-coordinates. One person skill in the art can understand that, the methods in FIG. 3B and FIG. 3C are substantially the same, with a difference that an error value is identified in FIG. 3B and a corrected real X-coordinate is identified in FIG. 3C.

Whether the table in FIG. 3A and FIG. 3B or FIG. 3C are used, these two LUTs require a larger memory space, i.e., a memory space of (m+1)*(n+1)+(m+1)*(m*n+1) units. Such memory space required is quite substantial to the memory module 140. Therefore, the memory space used according to another embodiment of the present invention can be reduced.

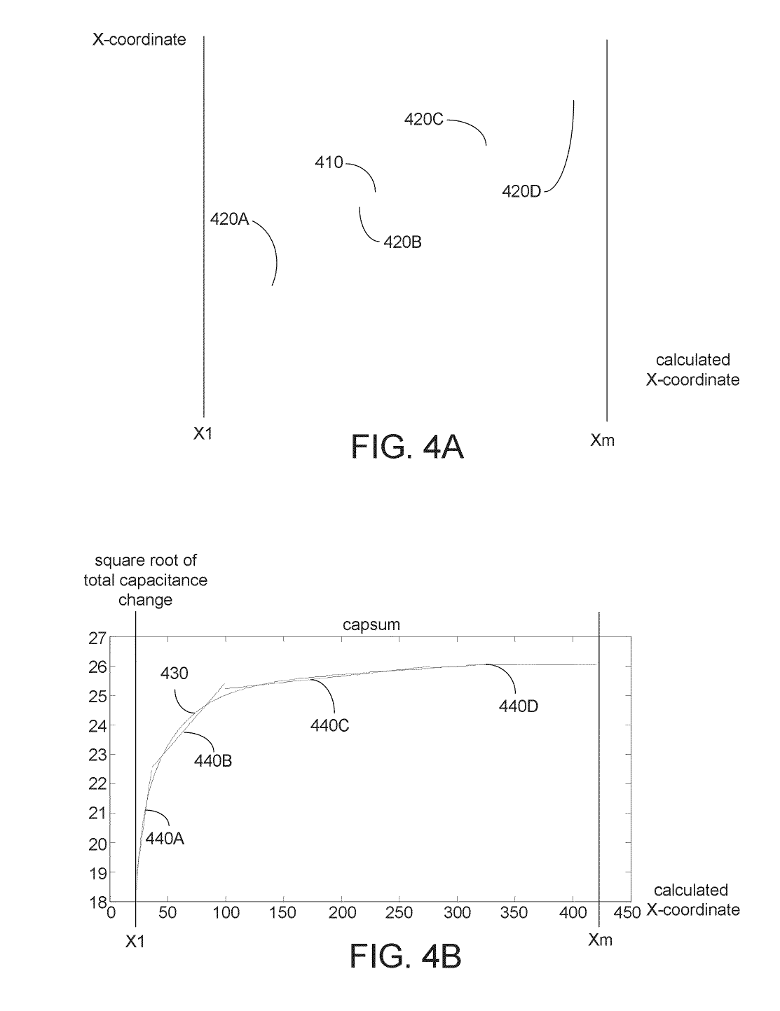

FIG. 4A shows a schematic diagram of calculated X-coordinates versus real X-coordinates according to an embodiment of the present invention. Corresponding to the square root of a certain total capacitance change, the correspondence between the calculated X-coordinate and the real X-coordinate can be described as in FIG. 4A, in which the horizontal axis represents the calculated X-coordinate and the vertical axis represents the real X-coordinate. In another embodiment, the vertical axis may be X-coordinate error values. FIG. 4A depicts a curve 410 indicating square roots of total capacitance changes corresponding to calculated X-coordinates, and a plurality of straight lines 420A to 420D approximating the curve 410. For example, a horizontal axis range of the curve 410 is between X1 and Xm.

In one embodiment, as errors between values of the straight lines 420A to 420D and corresponding values of the curve 410 fall within a limit, the straight lines 420A to 420D may be used to describe the curve 410. As such, given that the memory module 140 is recorded with slopes and starting points corresponding to the straight lines 420A to 420D, one corresponding straight line 420 may be identified according to the calculated X-coordinate to calculate the real X-coordinate or the X-coordinate error value, so as to further obtain the real X-coordinate.

FIG. 4B shows a schematic diagram of calculated X-coordinates versus square roots of total capacitance changes according to an embodiment of the present invention. The correspondence between of the calculated X-coordinate and the square root of the total capacitance change can be described as in FIG. 4B, in which the horizontal axis represents the calculated X-coordinate, and the vertical axis represents the square root of the total capacitance change. FIG. 4B depicts a curve 430 indicating square roots of total capacitance changes corresponding to calculated X-coordinates, and a plurality of straight lines 440A to 440D approximating the curve 430.

In the embodiment in FIG. 4A, from the straight lines 420 corresponding to the square roots of known total capacitance changes, a straight line 420 is identified according to the calculated X-coordinate to further obtain the real X-coordinate. In one embodiment, the LUT process for obtaining the square root of the total capacitance change may at the same time be obtained using the correspondence shown in FIG. 4B. In other words, an optional step may be added to FIG. 4B, i.e., the square root of the total capacitance change may be calculated by using the calculated X-coordinate and the curve 430.

In addition, if too much memory space is required for storing the curve 430, the straight lines 440A to 440D may also be used to approximate the curve 430. In other words, given that the starting points and slopes of the straight lines 440A to 440D are recorded, the square root of the corrected total capacitance change of can be calculated.

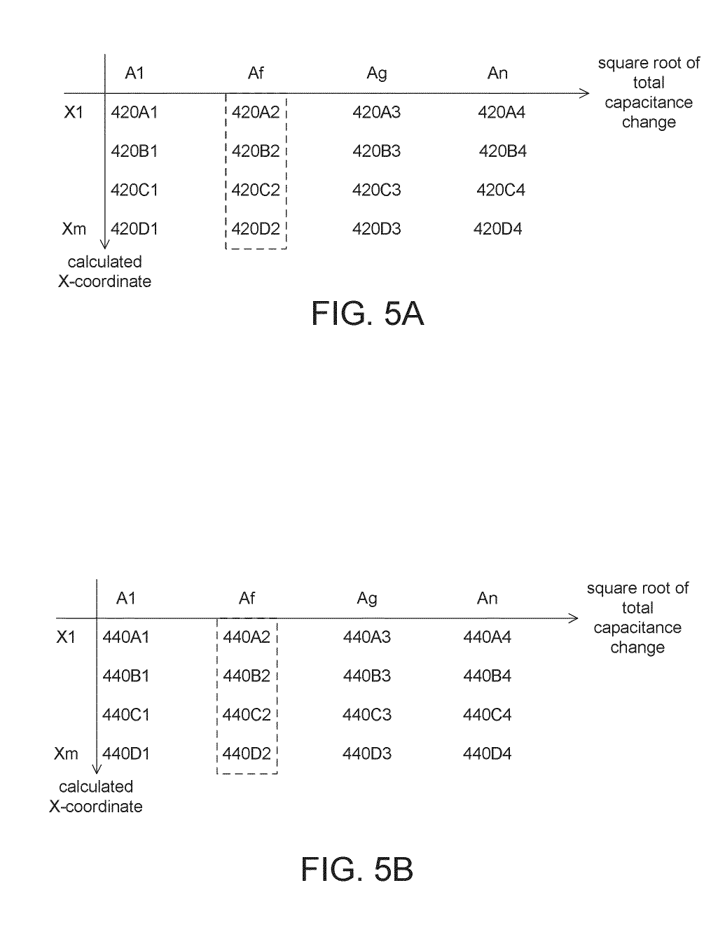

FIG. 5A shows a schematic diagram of memory contents according to an embodiment of the present invention. In FIG. 5A, the horizontal axis represents the square root of the total capacitance change, and has a range same as that in FIG. 3, with a smallest value being A1 and a largest value being An. In FIG. 5A, the vertical axis still represents the calculated X-coordinate, and has a range same as that in FIG. 3B, with the smallest value being X1 and the largest value being Xm. One difference of FIG. 5A from FIG. 3B or FIG. 3C is that, instead of the real X-coordinates or the X-coordinate error values, the stored contents are the starting points and the slopes of the straight lines 420.

The dotted frame indicates a set of straight lines 420A2 to 420D2, which may correspondingly approximate a curve 410 and also correspond to a square root Af of a certain total capacitance change. In other words, if it is known that the square root of the total capacitance change is Af and the calculated X-coordinate is between X1 and Xm, one corresponding straight line, e.g., 420B2, may be identified according to the calculated X-coordinate. Next, according to the recorded starting point and slope of the straight line 420B2, the calculated X-coordinate may be converted to the real X-coordinate.

FIG. 5B shows a schematic diagram of memory contents according to an embodiment of the present invention. In FIG. 5B, the horizontal axis represents the square root of the total capacitance change, and has a range same as that in FIG. 3C, with the smallest value being A1 and the largest value being An. In FIG. 5B, the vertical axis still represents the calculated X-coordinate, and has a range same as that in FIG. 3A, with the smallest value being X1 and the largest value being Xm. A difference of FIG. 5B from FIG. 3A is that, instead of the square roots of the total capacitance changes, the stored contents are the starting points and the slopes of the above straight lines 440.

The dotted frame indicates a set of straight lines 440A2 to 440D2, which may correspondingly approximate a curve 430 and also correspond to a square root Af of a certain total capacitance change. In other words, if the square root of the calculated total capacitance change is Af and the calculated X-coordinate is between X1 and Xm, one corresponding straight line, e.g., 440B2, may be identified according to the calculated X-coordinate. Next, according to the recorded starting point and slope of the straight line 440B2, the calculated total capacitance change may be converted to the square root of the corrected total capacitance change.

The ranges of the horizontal axis and the vertical axis in the embodiments in FIG. 5A and FIG. 5B are consistent and the numbers of columns in the two memory spaces are equal. However, it should be noted that, the present invention does not limit the ranges of the horizontal axis and the vertical axis to have the same ranges, nor does it limit the numbers of the columns of the memory spaces to be equal.

Assume that the memory contents in FIG. 5A correspond to p number of curves 410, each of the curves 410 corresponds to q number of straight lines 420, and a starting point and a slope of each of the straight lines are recorded. As p is far smaller than n, and q is far smaller than m, the memory space occupied by the embodiment in FIG. 5A is p*Q*2, which is far smaller than (m+1)*(m*n+1) in FIG. 3B. Assume that the memory contents in FIG. 5B correspond to r number of curves 430, each of the curves 430 corresponds to s number of straight lines 440, and a starting point and a slope of each of the straight lines are recorded. As r is far smaller than n and s is far smaller than m, the memory space occupied by the embodiment in FIG. 5B is r*s*2, which is far smaller than (m+1)*(m*n+1) in FIG. 3B. In conclusion, a large amount of memory space can be saved by utilizing the LUTs in FIG. 5A and FIG. 5B.

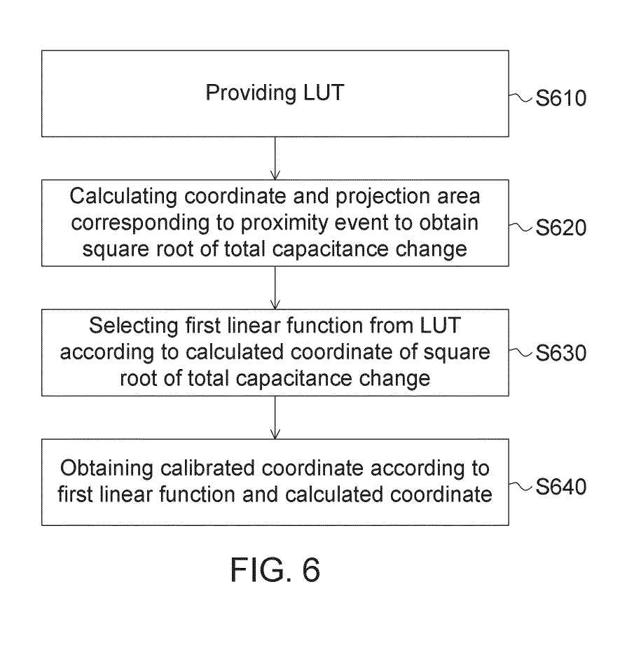

FIG. 6 shows a calibrating method according to an embodiment of the present invention. The calibrating method may be utilized as a method for calibrating a coordinate value near an edge of a touch panel, and is applicable to the embodiment in FIG. 1. Particularly, the processing method may perform the calibrating method in FIG. 6. In addition to the description below, the calibrating method may include the description of the above embodiments.

In step S610, an LUT is provided. The LUT may be located in a memory module 140 of the embodiment in FIG. 1. The LUT includes slopes and starting points of a plurality of linear functions corresponding to square roots of a plurality of total capacitance changes. In one embodiment, the first linear functions may be the straight lines 420A to 420D shown in FIG. 4A, or may be the straight lines 420A2 to 420D2 shown in FIG. 5A.

In step 620, a calculated coordinate and a projection area corresponding to a proximity event are calculated to obtain a square root of a total capacitance change.

In step 630, according to the calculated coordinate and the square root of the total capacitance change, a first linear function is selected from the first linear functions included in the LUT.

In step 640, a calibrated coordinate is obtained according to the first linear function and the calculated coordinate.

In one embodiment, the coordinate value represents an axial direction of the touch panel, which includes a plurality of sensing electrode units arranged along the axial direction.

In another embodiment, the square root of the total capacitance change is calculated according to the calculated coordinate. The LUT further includes slopes and starting points of a plurality of second linear functions (e.g., the straight lines 440), e.g., the straight lines 440A to 440D in FIG. 4B or the straight lines 440A2 to 440D2 in FIG. 5B. The calculation of the square root of the total capacitance change further includes: selecting a second linear function from the second linear functions included in the LUT according to the calculated coordinate and the projection area (or the capacitance change); and identifying a square root of the total capacitance change according to the linear function and the calculated coordinate.

In another embodiment, intervals of the calculated coordinates corresponding to the first linear functions corresponding to the square root of the same total capacitance change are different. Further, intervals of the calculated coordinates corresponding to the second linear functions corresponding to the same projection area are also different.

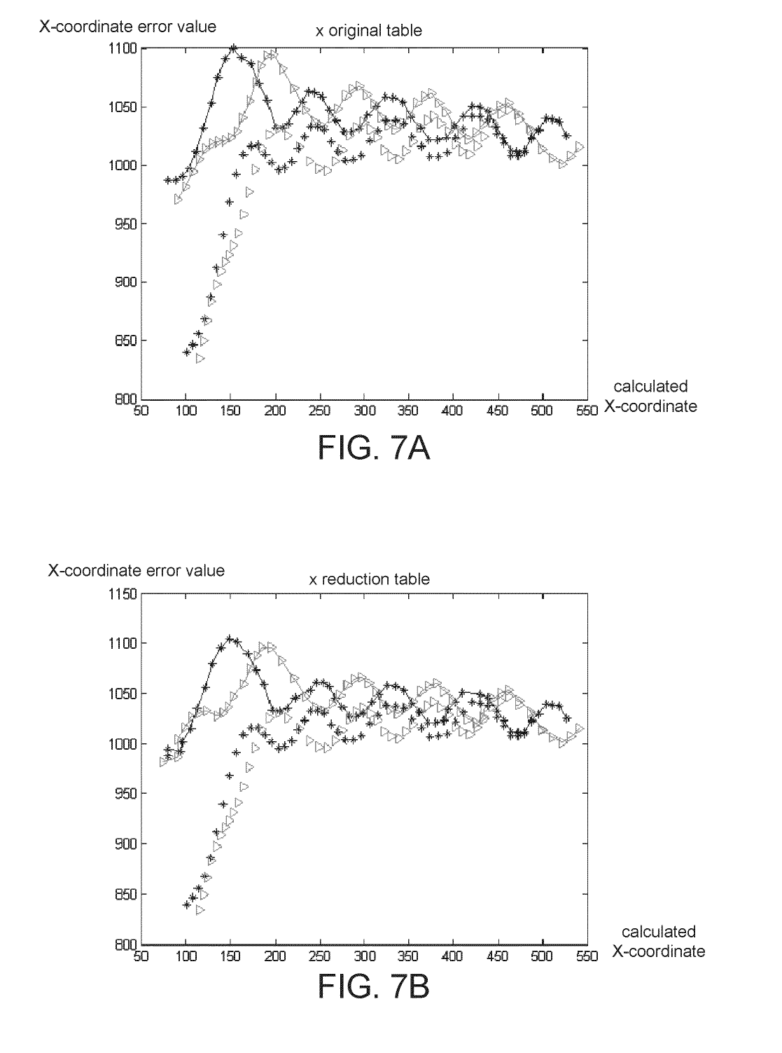

FIG. 7A shows a schematic diagram of corrected X-coordinates according to an embodiment of the present invention. In FIG. 7A, the horizontal axis represents the calculated X-coordinate, and the vertical axis represents the X-coordinate error value. The lines in FIG. 7A are obtained according to the embodiment in FIG. 3A or FIG. 3B, with each of the lines corresponding to square roots of different total capacitance changes.

FIG. 7B shows a schematic diagram of corrected X-coordinates according to another embodiment of the present invention. In FIG. 7B, the horizontal axis represents the calculated X-coordinate, and the vertical axis represents the X-coordinate error value. In FIG. 7B, the lines are obtained according to the embodiments in FIG. 5A or FIG. 6, with each of the lines corresponding to square roots of different total capacitance changes.

Comparing FIG. 7A and FIG. 7B, it is seen that the lines having been corrected are similar, with however the memory capacity consumed by the embodiment in FIG. 7A being far larger than that in FIG. 7B. In conclusion, one main spirit of the present invention is that, a plurality of linear functions are utilized to approximate a curve and memory consumption is reduced through a small amount of calculation, so as to obtain a similar corrected value.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for calibrating a coordinate value near an edge of a touch panel, comprising:
obtaining a calculated coordinate according to a capacitance change corresponding to a proximity event;
selecting a first linear function from a plurality of first linear functions comprised in a look-up table (LUT) according to the calculated coordinate and the capacitance change; and
obtaining a calibrated coordinate according to the first linear function and the calculated coordinate.

2. The method according to claim 1, wherein the calculated coordinate and the calibrated coordinate correspond to an axial direction of the touch panel, and the touch panel comprises a plurality of sensing electrode units arranged along the axial direction for sensing a plurality of capacitance changes of the touch panel.

3. The method according to claim 1, the step of selecting the first linear function from the LUT further comprises:
obtaining a square root of a total capacitance change according to the calculated coordinate and the capacitance change;
wherein, the LUT comprises slopes and starting points of the first linear functions corresponding to square roots of a plurality of total capacitance changes.

4. The method according to claim 3, wherein the LUT further comprises slopes and starting points of a plurality of second linear functions, and the step of obtaining the square root of the total capacitance change comprises:
selecting a second linear function from the second linear functions comprised in the LUT according to the calculated coordinate and a projection area, wherein the projection area is associated with the capacitance change of the touch panel; and
obtaining the square root of the total capacitance change according to the second linear function and the calculated coordinate.

5. The method according to claim 4, wherein intervals of the calculated coordinates corresponding to the first linear functions corresponding to the square root of the same capacitance change are different.

6. The method according to claim 4, wherein intervals of the calculated coordinates corresponding to the first linear functions corresponding to the same projection area are different.

7. A touch apparatus adapted to calibrate a coordinate value of a touch panel, comprising:
a memory module, comprising a look-up table (LUT); and
a processing module, coupled to the memory module to perform steps of:
obtaining a calculated coordinate according to a capacitance change corresponding to a proximity event;
selecting a first linear functions from the first linear functions comprised in the LUT according to the calculated coordinate and the capacitance change; and
obtaining a calibrated coordinate according to the first linear function and the calculated coordinate.

8. The touch apparatus according to claim 7, wherein the calculated coordinate and the calibrated coordinate correspond to an axial direction of the touch panel, and the touch panel comprises a plurality of sensing electrode units arranged along the axial direction for sensing a plurality of capacitance changes of the touch panel.

9. The touch apparatus according to claim 7, wherein the step of selecting the first linear function from the LUT further comprises:
obtaining a square root of a total capacitance change according to the calculated coordinate and the capacitance change;
wherein, the LUT comprises slopes and starting points of the first linear functions corresponding to square roots of a plurality of total capacitance changes.

10. The touch apparatus according to claim 9, wherein the LUT further comprises a plurality of second linear functions, and the step of obtaining the square root of the total capacitance comprises:
selecting a second linear function from the second linear functions comprised in the LUT according to the calculated coordinate and a projection area, wherein the projection area is associated with the capacitance change of the touch panel; and
obtaining the square root of the total capacitance change according to the second linear function and the calculated coordinate.

11. The touch apparatus according to claim 10, wherein intervals of the calculated coordinates corresponding to the first linear functions corresponding to the square root of the same capacitance change are different.

12. The touch apparatus according to claim 10, wherein intervals of the calculated coordinates corresponding to the first linear functions corresponding to the same projection area are different.
